(19) United States
(12) Patent Application Publication
(10) Pub. No.: US 2022/0300861 A1
(43) Pub. Date: Sep. 22, 2022

(54) MACHINE LEARNING TO CORRECT FOR NONPHOTOCHEMICAL QUENCHING IN HIGH-FREQUENCY, IN VIVO FLUOROMETER DATA

(71) Applicant: Mark A. Lucius, Glens Falls, NY (US)

(72) Inventor: Mark A. Lucius, Glens Falls, NY (US)

(73) Assignee: Rensselaer Polytechnic Institute, Troy, NY (US)

(21) Appl. No.: 17/696,102

(22) Filed: Mar. 16, 2022

Related U.S. Application Data
(60) Provisional application No. 63/161,500, filed on Mar. 16, 2021.

(51) Int. Cl. G06N 20/20; A01G 33/00

(52) U.S. Cl. CPC G06N 20/20; A01G 33/00

(57) ABSTRACT

A machine learning apparatus for correcting nonphotochemical quenching (NPQ) in fluorometer data includes a trained NPQ correction circuitry. The trained NPQ correction circuitry is configured to receive actual input NPQ data. The actual input NPQ data includes daytime chlorophyll a fluorescence (F_{chl}) data and selected environmental data. The trained NPQ correction circuitry is further configured to generate an estimated NPQ correction factor based, at least in part, on the actual input NPQ data. The NPQ correction factor is configured to at least reduce an effect of NPQ on the daytime F_{chl} data.

### CROSS REFERENCE TO RELATED APPLICATION(S)

This application claims the benefit of U.S. Provisional Application No. 63/161,500, filed Mar. 16, 2021, which is incorporated by reference as if disclosed herein in its entirety.

### FIELD

The present disclosure relates to machine learning, in particular to, machine learning to correct for nonphotochemical quenching in high-frequency, in vivo fluorometer data.

### BACKGROUND

Phytoplankton are an important component of freshwater food webs and their abundance and spatiotemporal distribution can influence the trophic status, designated uses, and economics of lakes and reservoirs. In vivo fluorometers use chlorophyll a fluorescence (F_{chl}) as a proxy to monitor phytoplankton biomass. However, the fluorescence yield of F_{chl} is affected by photoprotection processes triggered by increased irradiance (nonphotochemical quenching (NPQ)), creating diurnal reductions in F_{chl} that may be mistaken for phytoplankton biomass reductions, and thus error in assessing an amount of phytoplankton biomass present in a body of water (e.g., lake or reservoir).

### SUMMARY

In an embodiment, there is provided a machine learning apparatus for correcting nonphotochemical quenching (NPQ) in fluorometer data. The machine learning apparatus includes a trained NPQ correction circuitry. The trained NPQ correction circuitry is configured to receive actual input NPQ data. The actual input NPQ data includes daytime chlorophyll a fluorescence (F_{chl}) data and selected environmental data. The trained NPQ correction circuitry is further configured to generate an estimated NPQ correction factor based, at least in part, on the actual input NPQ data. The NPQ correction factor is configured to at least reduce an effect of NPQ on the daytime F_{chl} data.

In some embodiments of the machine learning apparatus, the trained NPQ correction circuitry is trained based, at least in part, on reference F_{chl} data, the reference F_{chl} data comprising nighttime F_{chl} data.

In some embodiments of the machine learning apparatus, the trained NPQ correction circuitry corresponds to a random forest regression.

In some embodiments of the machine learning apparatus, the selected environmental data is selected from the group including a total solar radiation (Eₜ), a depth, a numerical month of a year, a water temperature, a one hour rolling average of Eₜ, a dissolved oxygen (DO) saturation, and a solar azimuth angle.

In some embodiments of the machine learning apparatus, the actual input NPQ data has been preprocessed. The preprocessing is configured to at least one of reduce a number of outliers and/or to limit operation of the trained NPQ correction circuitry to a selected depth range.

In some embodiments of the machine learning apparatus, the estimated NPQ correction factor corresponds to a percent adjustment in F_{chl} related to NPQ.

In an embodiment, there is provided a machine learning system for correcting nonphotochemical quenching (NPQ) in fluorometer data. The machine learning system includes a computing device, an NPQ correction management module, and an NPQ correction circuitry. The computing device includes a processor, a memory, an input/output circuitry, and a data store. The NPQ correction management module is configured to receive input data. The NPQ correction circuitry is configured to receive input NPQ data and to generate an estimated NPQ correction factor based, at least in part, on the input NPQ data. The input NPQ data includes daytime chlorophyll a fluorescence (F_{chl}) data and selected environmental data. The estimated NPQ correction factor is configured to at least reduce an effect of NPQ on the daytime F_{chl} data.

In some embodiments of the machine learning system, the input data includes training input NPQ data and reference F_{chl} data. The reference F_{chl} data includes nighttime F_{chl} data. The NPQ correction management module is configured to train the NPQ correction circuitry based, at least in part, on the reference F_{chl} data.

In some embodiments of the machine learning system, the NPQ correction circuitry corresponds to a random forest regression.

In some embodiments of the machine learning system, the selected environmental data is selected from the group comprising a total solar radiation (Eₜ), a depth, a numerical month of a year, a water temperature, a one hour rolling average of Eₜ, a dissolved oxygen (DO) saturation, and a solar azimuth angle.

In some embodiments of the machine learning system, the input NPQ data has been preprocessed. The preprocessing is configured to at least one of reduce a number of outliers and/or to limit operation of the trained NPQ correction circuitry to a selected depth range.

In some embodiments of the machine learning system, the estimated NPQ correction factor corresponds to a percent adjustment in F_{chl} related to NPQ.

In some embodiments of the machine learning system, the NPQ correction management module is configured to generate a target NPQ correction factor based, at least in part, on the reference F_{chl} data. The training includes comparing the estimated NPQ correction factor and the target NPQ correction factor.

In some embodiments of the machine learning system, the NPQ correction management module is configured to adjust at least one correction circuitry parameter to minimize a difference between the estimated NPQ correction factor and the target NPQ correction factor.

In an embodiment, there is provided a method for correcting nonphotochemical quenching (NPQ) in fluorometer data. The method includes receiving, by an NPQ correction management module, input data. The method further includes receiving, by an NPQ correction circuitry, input NPQ data. The method further includes generating, by the NPQ correction circuitry, an estimated NPQ correction factor based, at least in part, on the input NPQ data. The input NPQ data includes daytime chlorophyll a fluorescence (F_{chl}) data and selected environmental data. The estimated NPQ correction factor is configured to at least reduce an effect of NPQ on the daytime F_{chl} data.

In some embodiments of the method, the input data includes training input NPQ data and reference F_{chl} data. The reference F_{chl} data includes nighttime F_{chl} data. In some embodiments the method further includes, training, by the NPQ correction management module, the NPQ correction circuitry based, at least in part, on the reference F_{chl} data.

In some embodiments of the method, the NPQ correction circuitry corresponds to a random forest regression.

In some embodiments of the method, the selected environmental data is selected from the group including a total solar radiation (Eₜ), a depth, a numerical month of a year, a water temperature, a one hour rolling average of Eₜ, a dissolved oxygen (DO) saturation, and a solar azimuth angle.

In some embodiments of the method, the estimated NPQ correction factor corresponds to a percent adjustment in F_{chl} related to NPQ.

In some embodiments, the method includes generating, by the NPQ correction management module, a target NPQ correction factor based, at least in part, on the reference F_{chl} data. The training includes comparing the estimated NPQ correction factor and the target NPQ correction factor.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a machine learning system for correcting for nonphotochemical quenching in high-frequency, in vivo fluorometer data, according to several embodiments of the present disclosure; and

FIG. 2 is a flowchart of operations for correcting for nonphotochemical quenching in high-frequency, in vivo fluorometer data, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a machine learning system configured to correct for nonphotochemical quenching (NPQ) in high-frequency, in vivo fluorometer data. As used herein, high-frequency corresponds to data collection at a rate of greater than or equal to six samples per hour. However, this disclosure is not limited in this regard. A method, apparatus and/or system may be configured to train an NPQ correction circuitry based, at least in part, on training data. In an embodiment, the NPQ correction circuitry corresponds to an NPQ model. In an embodiment, the NPQ model may correspond to a random forest regression.

The training data is configured to include training input NPQ data, and reference F_{chl} data. Input NPQ data (training and/or actual) is configured to include daytime F_{chl} data, and selected environmental data (i.e., one or more environmental parameter(s)), captured at predetermined time intervals over a daytime time period, and in some cases, at one or more incremental depths in the body of water under test. The daytime F_{chl} data may include one or more raw F_{chl} value(s) (in relative fluorescence units (RFU)) that may each correspond to a respective depth (i.e., water depth). The environmental parameters may include, but are not limited to, total solar radiation (Eₜ in watts per meter squared (Wm⁻²)), depth (in meters (m)), numerical month of the year, water temperature (in degrees Celsius (° C.)), one hour rolling average of Eₜ, dissolved oxygen (DO) saturation (in percent (%)), and solar azimuth angle.

The total solar radiation (Eₜ) may be captured at a solar radiation time interval and at a solar radiation distance above a water body surface. In one nonlimiting example, the solar radiation time interval may be on the order of tens of minutes (e.g., ten minutes), and the solar radiation distance may be on the order of ones of meters (e.g., 3 meters (m)). One or more of the environmental parameter values may be captured at a profiling data time interval. The profiling data time interval may be on the order of ones of minutes (e.g., 1.5 min.). However, this disclosure is not limited in this regard.

The reference F_{chl} data may include one or more measured F_{chl} value(s) (R_{iz}), captured at nighttime, at one or more depth(s). In the parameter R_{iz}, the subscript i corresponds to a nighttime time index and the subscript z corresponds to depth. The reference F_{chl} data thus corresponds to nighttime F_{chl} data and is thus configured to not include effects of NPQ.

A target NPQ correction factor (NPQ_{%}), used during training, may be determined based, at least in part, on reference F_{chl} data (R_{z}) and based, at least in part, on measured daytime F_{chl} data (F_{chl z}) where z corresponds to depth, in meters, below a surface of a target body of water. In an embodiment, the target NPQ correction factor may be determined as:

$$N P {Q}_{\%} = \frac{{F}_{c h l z} - \frac{{\sum }_{i = 1}^{n} {R}_{i z}}{n}}{\frac{{\sum }_{i = 1}^{n} {R}_{i z}}{n}} \qquad ( 1 )$$

where NPQ % is the target NPQ correction factor, F_{chl z} is measured daytime F_{chl} at depth, z, R_{iz} is nighttime F_{chl} at depth z, and time index i, i=1, 2, 3, . . . , n. In one example, n=2, and the corresponding start times for data acquisition were 02:00 and 04:00 Eastern Standard Time (EST). In another example, n=3, and the corresponding start times for data acquisition were 02:00, 03:00, and 04:00 Eastern Standard Time (EST).

$$\frac{{\sum }_{i = 1}^{n} {R}_{i z}}{n}$$

may thus correspond to R_{z}, an average (i.e., mean) of reference nighttime F_{chl} at depth z.

A difference between R_{z} and corresponding daytime sensor values may then correspond to an estimated magnitude of fluorescence quenching (in RFU). It is contemplated that fluorescence quenching may be caused primarily by NPQ based, at least in part, on an observable relationship with a relatively high solar irradiance. NPQ_{%} may then correspond to a percent difference between a nighttime reference value (unaffected by NPQ) and daytime fluorescence value (that may be reduced due to NPQ). NPQ_{%} may generally correspond to a negative percentage, i.e., R_{z} less than F_{chl}.

During training, the NPQ correction circuitry is configured to generate an estimated NPQ correction factor and one or more correction circuitry parameters may be adjusted to reduce a difference between the target NPQ correction factor and the estimated NPQ correction factor. The method, apparatus and/or system may then be configured to apply the trained NPQ correction circuitry (i.e., trained NPQ model) to actual input NPQ data. It may be appreciated that training data values may be specific to a particular body of water.

The trained NPQ model is configured to receive the actual input NPQ data, and to generate an estimated NPQ correction factor (NPQ_{%}) corresponding to a percent adjustment in F_{chl} related to NPQ. The estimated NPQ correction factor may then be applied to the measured daytime F_{chl} to produce a corrected daytime F_{chl}. The NPQ correction factor is configured to reduce and/or eliminate the effect(s) of NPQ on the daytime F_{chl} data, without measuring corresponding nighttime F_{chl} data. It may be appreciated that collecting data at night may not be a viable option (e.g., researchers without autonomous sensor platforms). It may thus be beneficial to correct daytime F_{chl} for NPQ, without corresponding nighttime F_{chl} data.

In one nonlimiting example, at least some input data may be acquired by a vertical profiler (VP) platform. However, this disclosure is not limited in this regard. The VP may include a computer-controlled, mechanical winch for depth-rated, water-quality instruments, and a multiparameter sonde. The sonde may be configured to measure pressure (e.g., to determine depth) and may include a plurality of probes configured to measure F_{chl}, phycocyanin fluorescence (a predominant accessory pigment found in cyanobacteria species), turbidity, conductivity, temperature, pH, oxidation-reduction potential (ORP), dissolved oxygen (DO), and fluorescent dissolved organic matter (fDOM). The probes may generally be calibrated and re-deployed at a predefined interval (e.g., monthly). Additionally or alternatively, the VP may include a weather transmitter and a pyranometer configured to capture meteorological data.

The VP may be configured to capture a vertical profile at a predefined data capture time interval. A duration of the predefined data capture time interval may be on the order of ones of hours. For example, the duration of the data capture time interval may be one hour. In another example, the data capture time interval duration may be two hours. Each profile may be initiated at an initial depth below a surface of a target body of water and continued to a maximum depth measured relative to a bottom of a body of water (e.g., a lake bed). In one nonlimiting example, the initial depth may be on the order of ones of meters (m) below the surface and the maximum depth may be on the order of ones of meters above the bottom of the lake bed. However, this disclosure is not limited in this regard. The VP may be configured to pause and dwell at selected incremental depths between the initial depth and the maximum depth. In one nonlimiting example, the depth increment may be on the order of 1 m and a dwell duration may be in a range of 30 second (s) to one minute. However, this disclosure is not limited in this regard. The dwell time at each depth increment is configured to facilitate stabilization of sonde sensor output prior to data capture.

Chl a fluorescence may be detected and recorded by a fluorometer. In one nonlimiting example, the fluorometer may have an excitation wavelength for Chl a fluorescence between 455 and 485 nanometers (nm), with 470 nm peak, and emission detection between 665 and 700 nm. However, this disclosure is not limited in this regard. The fluorometer sensors may be configured to provide fluorescence data in relative fluorescence units (RFU). Meteorological data, e.g., total solar radiation, may be collected at predefined collection intervals with a duration of on the order of tens of minutes (e.g., 10 min. intervals). For example, total solar radiation (Eₜ), including solar radiation with wavelengths in the range of 400-1100 nm, may be captured with sensors positioned a distance on the order of ones of meters above a surface of the body of water, e.g., a lake. In one nonlimiting example, the distance above the lake surface may be 3 m. The captured data may be recorded via a datalogger and may then be transmitted wirelessly to a computing device for storage and analysis, as described herein. Data capture intervals on the order of ones of minutes may correspond to relatively high-frequency data collection.

Additionally or alternatively to relatively high-frequency sensor data collection, data collection may include limnological sampling. Limnological sampling may include capturing one or more light profiles using, for example, a submersible PAR (Photosynthetically Active Radiation) sensor with a surface mounted reference sensor. Limnological sampling may be performed at sample intervals with durations of on the order of ones of weeks. In one nonlimiting example, limnological sampling may be performed, in climates where at least a surface of a body of water may freeze, after ice-out, at 2-week intervals throughout spring turnover until stratification has been established, e.g., in mid-June. Sampling may then occur at relatively longer intervals (e.g., 4 week interval) throughout the summer, switching back to 2-week intervals once fall turnover began.

In some embodiments, at least a portion of the input NPQ data may be preprocessed prior to training and/or prior to estimating the NPQ correction factor. The preprocessing is configured to facilitate operation of the machine learning system, method and/or apparatus for correcting NPQ in fluorometer data. For example, a filter may be applied to reduce outliers from the training input NPQ data. The filter may be configured to eliminate samples outside of a selected number (e.g., five) of standard deviations in a corresponding distribution of samples. For example, a rolling window standard deviation filter may be applied to each depth for each time sample. Any value exceeding ±5 standard deviations of a corresponding rolling mean may be removed.

It may be appreciated that NPQ may be caused by relatively high light intensity at a selected depth, and light intensity may decrease as depth increases. Thus, F_{chl} data considered to be at depths affected by NPQ may be included in training and/or actual input NPQ data, and F_{chl} data considered to be at depths not affected by NPQ may be excluded. For example, F_{chl} data considered to be affected may be identified based, at least in part, on a determined subsurface solar irradiance (E_{z}), determined based, at least in part, on a diffuse attenuation coefficient for downwelling irradiance (K_{d}), the Beer-Lambert Law and a plurality of existing light profiles. For example, K_{d} may be determined using the light profiles and the Beer-Lambert law, and E_{z} may then be determined via interpolation for all observations in a dataset. It may be appreciated that K_{d} values may have relatively low variability over a data collection period and light attenuation may have relatively low historic variability. Thus, in some situations, a single K_{d} value rather than depth-specific K_{d} values may be used. For example, the single K_{d} value may be estimated by Secchi depth. F_{chl} data for depths with E_{z} values below a selected threshold may then be excluded from the training data and daytime F_{chl} values may not be corrected. Thus, preprocessing may limit operations to a selected depth range.

In another example, for environmental data captured at different intervals, at least some of the environmental data may be interpolated (e.g., by linear interpolation) to generate interpolated samples between actual samples. In one nonlimiting example, total solar radiation (Et) data may be collected at 10-min intervals, while vertical profiling data may be collected at approximately 1.5-min intervals. A linear interpolation of the solar radiation data may then be performed to provide interpolated total solar radiation data at 1.5 min. intervals, between the actual total solar radiation samples. Such interpolation is configured to facilitate NPQ correction circuitry training with time series (i.e., time sampled) training data and correction operations for a trained NPQ correction circuitry.

Thus, in some embodiments, training and actual input NPQ data and/or reference F_{chl} data may be preprocessed to facilitate training and/or correction operations, as described herein.

In an embodiment, there is provided a machine learning apparatus for correcting nonphotochemical quenching (NPQ) in fluorometer data. The machine learning apparatus includes a trained NPQ correction circuitry. The trained NPQ correction circuitry is configured to receive actual input NPQ data. The actual input NPQ data includes daytime chlorophyll a fluorescence (F_{chl}) data and selected environmental data. The trained NPQ correction circuitry is further configured to generate an estimated NPQ correction factor based, at least in part, on the actual input NPQ data. The NPQ correction factor is configured to at least reduce an effect of NPQ on the daytime F_{chl} data.

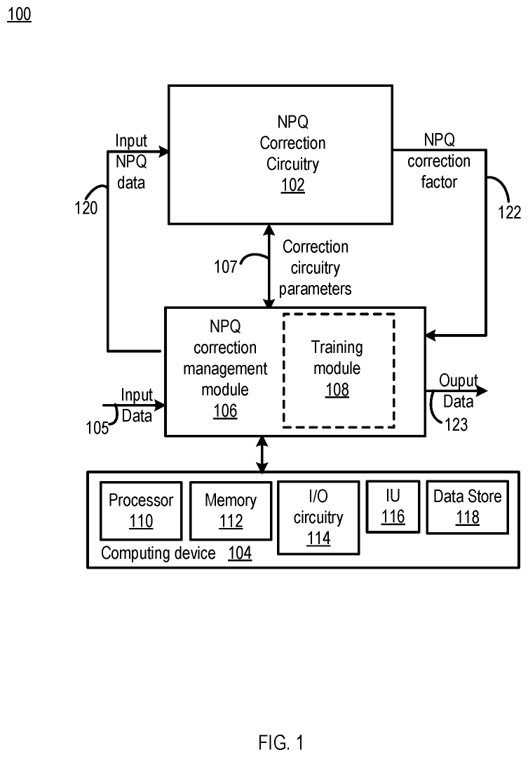

FIG. 1 illustrates a functional block diagram 100 of a machine learning system for correcting for nonphotochemical quenching (NPQ) in high-frequency, in vivo fluorometer data, according to several embodiments of the present disclosure. Machine learning system 100 includes an NPQ correction circuitry 102, a computing device 104, and an NPQ correction management module 106. In some embodiments, machine learning system 100, e.g., NPQ correction management module 106, may include a training module 108. NPQ correction circuitry 102 and/or NPQ correction management module 106 may be coupled to or included in computing device 104.

The NPQ correction management module 106 is configured to receive input data 105, to provide input NPQ data 120 to NPQ correction circuitry 102, to receive an NPQ correction factor 122 from NPQ circuitry 102, and to provide output data 123, as will be described in more detail below. The NPQ correction circuitry 102 is configured to receive input NPQ data 120 and to provide the NPQ correction factor 122, related to correcting a daytime F_{chl} value to reduce effects of NPQ, as described herein. The input NPQ data is configured to include daytime F_{chl} data and selected environmental data, as described herein.

NPQ correction circuitry 102 is configured to generate a correction for F_{chl}, related to NPQ, that is based, at least in part, on input NPQ data 120. NPQ correction circuitry 102 may thus be configured to implement, and/or may correspond to, an NPQ model. An NPQ model may include, but is not limited to, a regression (e.g., random forest regression, a gradient boosting regression, a support vector regression, a multiple linear regression, a mixed-effects model, an exponential regression, etc.), an artificial neural network (ANN), a convolutional neural network (CNN), a multilayer perceptron (MLP), etc. NPQ correction circuitry 102 may thus be included in or may correspond to a machine learning apparatus, configured to be trained using a machine learning technique. In an embodiment, NPQ correction circuitry 102 may correspond to a random forest regression model.

Computing device 104 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 104 includes a processor 110, a memory 112, input/output (I/O) circuitry 114, a user interface (UI) 116, and data store 118.

Processor 110 is configured to perform operations of NPQ correction circuitry 102 and/or

NPQ correction management module 106. Memory 112 may be configured to store data associated with NPQ correction circuitry 102 and/or NPQ correction management module 106. I/O circuitry 114 may be configured to provide wired and/or wireless communication functionality for machine learning system 100. For example, I/O circuitry 114 may be configured to receive input data 105 (e.g., input NPQ data 120 and/or training data) and to provide output data 123. UI 116 may include a user input device (e.g., keyboard, mouse, microphone, touch sensitive display, etc.) and/or a user output device, e.g., a display. Data store 118 may be configured to store one or more of input data 105, input NPQ data 120, NPQ correction factor 122, output data 123, correction circuitry parameters 107, and data associated with NPQ correction management module 106 and/or training module 108. Data associated with training module 108 may include, for example, training data, as described herein.

NPQ correction circuitry 102 may be trained by NPQ correction management module 106 and/or training module 108 based, at least in part, on training data. Training data may be included in input data 105 received by NPQ correction management module 106. Input data 105 may thus include training data (e.g., training input NPQ data and reference F_{chl} data (R_{z})), for training operations, and/or actual input NPQ data during NPQ correction operations, as described herein. Input NPQ data (training and/or actual) includes daytime F_{chl} data and selected environmental data (i.e., environmental parameters). The environmental parameters may include, but are not limited to, total solar radiation (Eₜ), depth, numerical month of the year, water temperature, one hour rolling average of Eₜ, DO, and solar azimuth angle, as described herein.

In operation, input data 105 may be received by NPQ correction management module 106 and may then be stored in data store 118. NPQ correction management module 106, e.g., training module 108, may be configured to train NPQ correction circuitry 102 using training data. Training operations may generally include, for example, providing training input NPQ data to NPQ correction circuitry 102, capturing NPQ correction factor 122, i.e., estimated NPQ correction factor, from the NPQ correction circuitry 102, comparing the estimated NPQ correction factor to a corresponding training NPQ correction factor, i.e., target NPQ correction factor, and adjusting one of more correction circuitry parameters 107 based, at least in part, on a result of the comparison.

During training, NPQ correction management module 106 is configured to provide training input NPQ data (i.e., daytime F_{chl} data, and selected environmental parameter values, as described herein) to NPQ correction circuitry 102, and to receive an estimated NPQ correction factor 122 from NPQ correction circuitry 102. NPQ correction management module 106 and/or training module 108 may be configured to determine a target NPQ correction factor based, at least in part, on training daytime F_{chl} data, and based, at least in part, on reference F_{chl} data. In one nonlimiting example, the target NPQ correction factor may be determined according to equation (1). Training module 108 is further configured to compare the estimated and the target NPQ correction factors, and to adjust one or more of the correction circuitry parameters 107 based, at least in part, on the comparison. Adjusting the correction circuitry parameters 107 may be based on an error function (e.g., root mean squared error (RSME), mean absolute error (MAE), etc.), and may be configured to minimize the error function. It may be appreciated that other error functions may also be used, within the scope of this disclosure. After training, correction circuitry parameters 107 may generally be fixed.

In an embodiment, NPQ correction circuitry 102 may correspond to a random forest regression model. The random forest regression model may be configured according to a number of regression model parameters. The regression model parameters may include, but are not limited to, a number of estimators (i.e., a total number of regression trees in the NPQ model), a maximum features parameter (i.e., a size of a subset of total features randomly chosen at each node), and a maximum tree depth. In one nonlimiting example, the random forest regression model may include on the order of hundreds of estimators (e.g., 500) and on the order of tens of levels (e.g., 15) corresponding to maximum tree depth. Continuing with this example, the maximum features parameter may correspond to one half of a number of inputs to the node. It may be appreciated that each node in a random forest may be split using a best among a randomly chosen subset of the total features. However, this disclosure is not limited in this regard.

In one nonlimiting example, a model accuracy may be assessed using, for example, a 10-fold grouped cross-validation with data grouped by day of the year. The model may be trained on 90% of days in the data and the accuracy may be tested on the remaining 10%. This may be repeated 10 times until each section has been used for accuracy testing. The average accuracy from all 10 splits may then be recorded. This type of grouped cross-validation is configured to reduce or eliminate autocorrelation in temporally adjacent data (i.e., from the same day) found in both training and testing datasets.

After cross-validation, as described herein, model parameters may be tuned to minimize or reduce an error function, e.g., RSME. In one nonlimiting example, the number of estimators may be 500, the maximum tree depth may be 15 and the maximum features parameter may correspond to one half the number of inputs. The number of estimators may be configured to balance processing time and RMSE. The number of predictors tested at each node was set to half of the total number of inputs. The maximum tree depth may be configured to reduce or prevent overfitting the model. The maximum tree depth may affect training data correction. Including relatively deeper trees may prevent a model from generalizing when predicting unseen data by overfitting the model to the particularities of the training dataset.

Thus, during training, NPQ correction circuitry 102 is configured to receive the training input NPQ data from NPQ correction management module 106, and to determine an estimated NPQ correction factor (NPQ_{%}) based, at least in part, on the training input NPQ data. NPQ correction circuitry 102 may be further configured to provide the estimated NPQ correction factor 122 to NPQ correction management module 106.

In some embodiments, NPQ correction management module 106 may be configured to preprocess at least some of the input data 105, as described herein. The preprocessing may be configured to reduce or eliminate outliers, and/or to reduce or eliminate processing daytime F_{chl} data for depths not susceptible to NPQ. The preprocessing may be performed prior to training and/or NPQ estimation operations. It is contemplated that preprocessing, as described herein, may be performed prior to provision of input data to machine learning system 100, or may be performed by NPQ correction management module, after the input data 105 is received.

After training, NPQ correction management module 106 is configured to receive input data 105 that includes actual input NPQ data, as described herein. NPQ correction management module 106 may be further configured to provide the actual input NPQ data to NPQ correction circuitry 102. NPQ correction circuitry 102 is then configured to generate a corresponding NPQ correction factor 122, i.e., NPQ_{%}. The corresponding NPQ correction factor 122 may then be provided to NPQ correction management module 106.

In an embodiment, NPQ correction management module 106 may be configured to provide the corresponding NPQ correction factor 122 to another system, e.g., a fluorometer, configured to correct a daytime F_{chl} value. In this embodiment, the output data 123 may correspond to the NPQ correction factor 122. In another embodiment, NPQ correction management module 106 may be configured to correct the received daytime F_{chl} data based, at least in part, on the corresponding NPQ correction factor 122, to yield a corrected daytime F_{chl} value that is corrected for NPQ. In this embodiment, the output data 123 may then correspond to a corrected daytime F_{chl} value. NPQ correction management module 106 may then be configured to provide as output, output data 123 that corresponds to received input NPQ data.

Thus, after training, NPQ correction circuitry 102 may be configured to generate a correction factor for NPQ effects in daytime F_{chl} data while avoiding capturing nighttime F_{chl} data. In one nonlimiting example, NPQ correction circuitry 102 may correspond to a random forest regression.

Thus, a trained NPQ model (i.e., NPQ correction circuitry 102) is configured to receive actual input NPQ data, and to generate an estimated NPQ correction factor (NPQ_{%}) corresponding to a percent adjustment in F_{chl} related to NPQ. The estimated NPQ correction factor may then be applied to the measured daytime F_{chl} to produce a corrected daytime F_{chl}. The NPQ correction factor is configured to reduce and/or eliminate the effect(s) of NPQ on the daytime F_{chl} data, without measuring corresponding nighttime F_{chl} data. It may be appreciated that collecting data at night may not be a viable option. It may thus be beneficial to correct daytime F_{chl} for NPQ, without corresponding nighttime F_{chl} data.

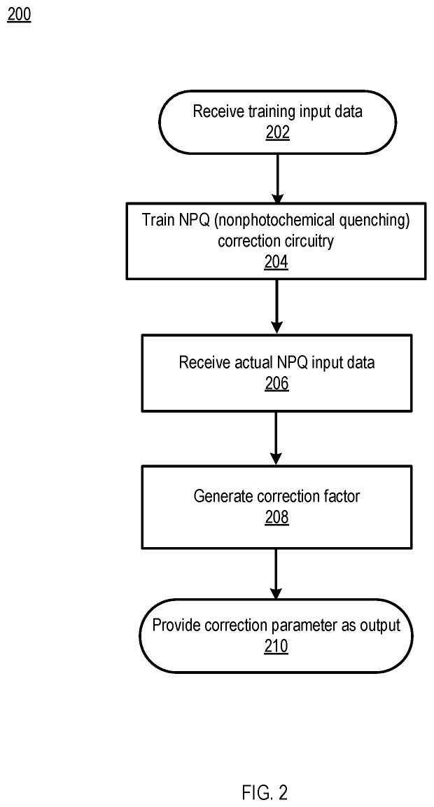

FIG. 2 is a flowchart 200 of operations for correcting for nonphotochemical quenching in high-frequency, in vivo fluorometer data, according to various embodiments of the present disclosure. In particular, the flowchart 200 illustrates training and using a machine learning system for correcting for nonphotochemical quenching in high-frequency, in vivo fluorometer data. The operations may be performed, for example, by the machine learning system 100 (e.g., NPQ correction circuitry 102, NPQ correction management module 106, and/or training module 108) of FIG. 1.

Operations of this embodiment may begin with receiving training input data at operation 202. Operation 204 includes training NPQ correction circuitry. Operation 206 includes receiving actual NPQ input data. Operation 208 includes generating a correction factor. A correction parameter may be provided as output at operation 210. In one example, the correction parameter may be the correction factor. In another example, the correction parameter may correspond to corrected daytime F_{chl} data.

Thus, a machine learning system may be trained and may then be configured to provide correction factor for NPQ.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A machine learning apparatus for correcting nonphotochemical quenching (NPQ) in fluorometer data, the machine learning apparatus comprising:
a trained NPQ correction circuitry configured to receive actual input NPQ data, the actual input NPQ data comprising daytime chlorophyll a fluorescence (F_{chl}) data and selected environmental data,
the trained NPQ correction circuitry further configured to generate an estimated NPQ correction factor based, at least in part, on the actual input NPQ data,
the NPQ correction factor configured to at least reduce an effect of NPQ on the daytime F_{chl} data.

2. The machine learning apparatus of claim 1, wherein the trained NPQ correction circuitry is trained based, at least in part, on reference F_{chl} data, the reference F_{chl} data comprising nighttime F_{chl} data.

3. The machine learning apparatus of claim 1, wherein the trained NPQ correction circuitry corresponds to a random forest regression.

4. The machine learning apparatus of claim 1, wherein the selected environmental data is selected from the group comprising a total solar radiation (Eₜ), a depth, a numerical month of a year, a water temperature, a one hour rolling average of Eₜ, a dissolved oxygen (DO) saturation, and a solar azimuth angle.

5. The machine learning apparatus of claim 1, wherein the actual input NPQ data has been preprocessed, the preprocessing configured to at least one of reduce a number of outliers and/or to limit operation of the trained NPQ correction circuitry to a selected depth range.

6. The machine learning apparatus of claim 1, wherein the estimated NPQ correction factor corresponds to a percent adjustment in F_{chl} related to NPQ.

7. A machine learning system for correcting nonphotochemical quenching (NPQ) in fluorometer data, the machine learning system comprising:
a computing device comprising a processor, a memory, an input/output circuitry, and a data store;
an NPQ correction management module configured to receive input data; and
an NPQ correction circuitry configured to receive input NPQ data and to generate an estimated NPQ correction factor based, at least in part, on the input NPQ data, the input NPQ data comprising daytime chlorophyll a fluorescence (F_{chl}) data and selected environmental data,
the estimated NPQ correction factor configured to at least reduce an effect of NPQ on the daytime F_{chl} data.

8. The machine learning system of claim 7, wherein the input data comprises training input NPQ data and reference F_{chl} data, the reference F_{chl} data comprises nighttime F_{chl} data, and the NPQ correction management module is configured to train the NPQ correction circuitry based, at least in part, on the reference F_{chl} data.

9. The machine learning system of claim 7, wherein the NPQ correction circuitry corresponds to a random forest regression.

10. The machine learning system of claim 7, wherein the selected environmental data is selected from the group comprising a total solar radiation (Eₜ), a depth, a numerical month of a year, a water temperature, a one hour rolling average of Eₜ, a dissolved oxygen (DO) saturation, and a solar azimuth angle.

11. The machine learning system of claim 7, wherein the input NPQ data has been preprocessed, the preprocessing configured to at least one of reduce a number of outliers and/or to limit operation of the trained NPQ correction circuitry to a selected depth range.

12. The machine learning system of claim 7, wherein the estimated NPQ correction factor corresponds to a percent adjustment in F_{chl} related to NPQ.

13. The machine learning system of claim 8, wherein the NPQ correction management module is configured to generate a target NPQ correction factor based, at least in part, on the reference F_{chl} data, the training comprising comparing the estimated NPQ correction factor and the target NPQ correction factor.

14. The machine learning system of claim 13, wherein the NPQ correction management module is configured to adjust at least one correction circuitry parameter to minimize a difference between the estimated NPQ correction factor and the target NPQ correction factor.

15. A method for correcting nonphotochemical quenching (NPQ) in fluorometer data, the method comprising:
receiving, by an NPQ correction management module, input data;
receiving, by an NPQ correction circuitry, input NPQ data; and
generating, by the NPQ correction circuitry, an estimated NPQ correction factor based, at least in part, on the input NPQ data, the input NPQ data comprising daytime chlorophyll a fluorescence (F_{chl}) data and selected environmental data,
the estimated NPQ correction factor configured to at least reduce an effect of NPQ on the daytime F_{chl} data.

16. The method of claim 15, wherein the input data comprises training input NPQ data and reference F_{chl} data, the reference F_{chl} data comprises nighttime F_{chl} data, and further comprising, training, by the NPQ correction management module, the NPQ correction circuitry based, at least in part, on the reference F_{chl} data.

17. The method of claim 15, wherein the NPQ correction circuitry corresponds to a random forest regression.

18. The method of claim 15, wherein the selected environmental data is selected from the group comprising a total solar radiation (Eₜ), a depth, a numerical month of a year, a water temperature, a one hour rolling average of Eₜ, a dissolved oxygen (DO) saturation, and a solar azimuth angle.

19. The method of claim 15, wherein the estimated NPQ correction factor corresponds to a percent adjustment in F_{chl} related to NPQ.

20. The method of claim 15, further comprising generating, by the NPQ correction management module, a target NPQ correction factor based, at least in part, on the reference F_{chl} data, the training comprising comparing the estimated NPQ correction factor and the target NPQ correction factor.
